(19) United States
(12) Patent Application Publication
(10) Pub. No.: US 2024/0420198 A1
(43) Pub. Date: Dec. 19, 2024

(54) METHODS AND SYSTEMS FOR IN-TRANSIT AUGMENTATION OF REAL-TIME VIDEO ASSISTANCE COMMUNICATION

(71) Applicant: Verizon Patent and Licensing Inc., Basking Ridge, NJ (US)

(72) Inventors: Niral Krushnadev Trivedi, Hillsborough, NJ (US); Robert Bonagura, Three Bridges, NJ (US); Gopal K Mandava, Centerville, VA (US)

(21) Appl. No.: 18/210,344

(22) Filed: Jun. 15, 2023

(51) Int. Cl. G06Q 30/0601; G06T 11/00; G06T 13/00

(52) U.S. Cl. CPC G06Q 30/0613; G06T 11/00; G06T 13/00

(57) ABSTRACT

An illustrative graphics rendering engine may receive, by way of a network connection with a first communication endpoint separate from the graphics rendering engine, a real-time video communication generated at the first communication endpoint for communication with a second communication endpoint separate from the graphics rendering engine. The graphics rendering engine may access a graphical representation of an object from a data store separate from the first and second communication endpoints. As the real-time video communication is being received, the graphics rendering engine may generate an augmented video communication featuring the graphical representation of the object overlaid onto a background texture depicting the real-time video communication. The graphics rendering engine may transmit this augmented video communication to the second communication endpoint in real time as the augmented video communication is being generated. Corresponding methods and systems are also disclosed.

### BACKGROUND INFORMATION

Various types of businesses, including wireless carriers and other service providers, engage in communications with their customers for a variety of reasons. For example, such communications may be conducted in furtherance of sales transactions (e.g., to sell new devices or services, to offer discounts or promotions on new hardware or plans, etc.), customer support transactions (e.g., technical support to troubleshoot problems with devices or help set up new devices; service support to resolve complaints or answer questions about customer accounts, etc.), and/or other such matters that may call for communication between the customer and a representative of the business.

While many organizations may aim to create client communication programs whereby productive and efficient customer communications serve as important contributors to the success of the organizations (e.g., by increasing sales, providing better products and services, improving customer satisfaction, etc.), achieving such ideal communication is difficult for a variety of reasons. Moreover, even if a successful communications program has been established and is presently benefiting a particular organization, there may still exist room to further improve and innovate so as to make the communications even more effective with regard to the various goals that the organization may have.

### BRIEF DESCRIPTION OF THE DRAWINGS

The accompanying drawings illustrate various embodiments and are a part of the specification. The illustrated embodiments are merely examples and do not limit the scope of the disclosure. Throughout the drawings, identical or similar reference numbers designate identical or similar elements.

FIG. 1 shows an illustrative graphics rendering engine implemented by a computing device and configured to facilitate in-transit augmentation of real-time video assistance communication in accordance with principles described herein.

FIG. 2 shows an illustrative method for in-transit augmentation of real-time video assistance communication in accordance with principles described herein.

FIG. 3 shows illustrative configurations in which video communications are conducted in accordance with principles described herein.

FIG. 4 shows illustrative aspects for constructing an example user interface used for real-time, augmented video communications in accordance with principles described herein.

FIGS. 5-9 show illustrative snapshots of various user interfaces for real-time, augmented video communication as different transactions and operations are carried out in accordance with principles described herein.

FIG. 10 shows an illustrative computing system that may implement graphics rendering engines for in-transit augmentation of real-time video assistance communication and/or other computing systems described herein.

### DETAILED DESCRIPTION OF EXAMPLE EMBODIMENTS

Methods and systems for in-transit augmentation of real-time video assistance communication are described herein. As mentioned above, programs for customer communications implemented by certain organizations face various challenges and opportunities for improvement. As one example affecting businesses like wireless carriers or electronics retailers (or other such organizations that sell or otherwise distribute electronic devices such as smartphones, tablets, laptops, smartwatches and other wearable devices, e-readers, etc.), there may be an enormous number of models and variations of physical devices that businesses offer to customers, such that it can be difficult during a customer support or sales transaction to demonstrate the exact device that is being discussed.

Consider, for instance, a common sales scenario for such businesses in which a prospective customer is in the market for a new mobile device, of which the retailer may offer a large number (various models with various variations from various brands). Even if a sales representative is knowledgeable about the various brands and models available and how they might compare to the prospective customer's current phone, and even if the sales call is being carried out over a video link such that the representative can demonstrate certain brands and models to the customer over the video link, there may be a very limited number of different devices that the representative can access and exhibit to the customer in a reasonable amount of time. Accordingly, if a customer is interested in a certain brand and model of a device and the representative does not have that exact model immediately available (e.g., without ordering one from a different store, without pausing the call to go to find one in the back room, etc.), the representative may have to settle for exhibiting a similar model from the same brand (e.g., “so it would basically look like this, but it would be a little smaller and only have the one camera here . . . ”). As another possibility, the representative could have the right model but not the right color (or some other variation), forcing the prospective customer to try to imagine what he or she would be purchasing (e.g., “so this is the phone in midnight black, but the one you're talking about would be shinier and not quite this dark . . . ”). Moreover, if the customer currently owns a particular mobile device from a few years ago (e.g., a particular model from a particular brand with particular variations such as colors, finishes, cameras, screen upgrades, storage amounts, etc.), it will again be up to the customer to try to imagine how various new options (various different models, brands, variations, etc.) would be different from what the customer already has.

To address these and other challenges, methods and systems for in-transit augmentation of real-time video assistance communication described herein may be configured to input video communications (e.g., standard communications transmitted using WebRTC or other such technologies) as they are in transit or enroute to a destination. Essentially, the communications may be “intercepted” by a system different from either of the communication endpoints (e.g., a multi-access edge compute (“MEC”) server, a cloud-based compute system, an on-site augmentation server operated by the business entity sending the communication, etc.). This system may implement a graphics rendering engine (e.g., a 3D rendering engine such as a game engine or other graphics rendering system configured to handle and manipulate representations of 2D and 3D objects) that accesses and augments the communication with one or more graphical object representations relevant to the transaction (e.g., one or more 3D models of electronic devices for the sales transaction example described above or other 2D or 3D object representations for other examples). The rendering engine may then send the augmented video communication on its way to the other communication endpoint (e.g., to the customer), where a viewer will be presented with the original video communication (e.g., depicting the service representative for the company) overlaid with the augmentation (e.g., the graphical representation of the device). In some aspects, one or more of the participants in the video communication are able to control and manipulate the models and/or other portions of the augmentation. In this way, and as will be described in detail below, various types of objects may be presented and more easily visualized to facilitate various types of transactions and communications that the two parties may be involved with (e.g., sales transactions, customer service transactions, technical support transactions, etc.).

While certain augmented video communications (e.g., social media apps in which facial distortions, personalized emoji, added accessories, false backgrounds, and/or other augmentations) have become popular in recent years, the video assist architecture described herein, in which a separate rendering engine augments a video communication stream with a graphical object representation as the video communication is in transit to a destination endpoint, is novel and beneficial over existing technologies in several respects. For example, offloading the graphics processing and the data storage of object representations to systems separate from the communication endpoints (e.g., MEC systems, cloud systems, etc.) provides significant flexibility and efficiency as compared to conventional applications that store and process augmentation data locally on the communication endpoints (e.g., the consumer devices being used to communicate). As will be described in more detail below, a data store separate from the relatively limited resources of the communication endpoints may store detailed models (e.g., full 3D models) representing thousands of electronic devices (with all their makes and models and all their variations, past and present), as well as other data such as 2D or 3D representations of available accessories to the devices, preproduced animations for the devices, customer account data, and any other data employed in use cases described herein. Moreover, by processing this data at a dedicated graphics rendering engine (e.g., implemented, in some instances, by a powerful server with significant resources beyond those that a typical communication endpoint would have), various 2D and/or 3D manipulations of the object (including translations, rotations, scale changes, annotations, animations, etc.) and other graphics processing techniques may be implemented with minimal or no extra processing required from the communication endpoints used by the users.

With these flexible ways of communicating object representations for physical devices and/or other objects, various communication benefits arise for both business organizations and their customers. For example, 360-degree views of specific objects (e.g., any of thousands of device models with exact features and variations that are desired, any of thousands of device accessories, etc.) may be demonstrated and viewed conveniently whether or not such objects are close at hand physically (e.g., whether or not they are in stock in the store or are even still being produced in the case of older models, etc.). Products may be compared side by side (e.g., old products compared to new products, alternative new products that are competing for the customer's business, etc.) and may be viewed in close-up detail to demonstrate certain technical aspects that could be difficult to demonstrate even in person with physical devices (e.g., replacing a SIM card, moving data from one particular device to another, etc.).

Additionally, data other than graphical object representations (e.g., 3D models of electronic devices, etc.) may also be presented in this way to enable other beneficial use cases. For instance, as will be described and illustrated, machine-readable codes may be augmented onto video communications to facilitate certain transactions, customer account information may be pulled up and jointly examined by both parties without risk of violating rules or regulations precluding traditional screen sharing of sensitive information, and so forth. In all of these ways, customers may receive more effective and satisfying service while the businesses serving them may enjoy increased sales and improved outcomes along various dimensions (personnel efficiency, sales conversion rates, successful troubleshooting of tech support issues, fewer disputed bills, etc.). Moreover, the architectures described herein may be implemented on top of any video conferencing platform without the need for specially developed software (e.g., native SDKs) or other costly implementation requirements.

Various specific implementations will now be described in detail with reference to the figures. It will be understood that the specific implementations described below are provided as non-limiting examples and may be applied in various situations. Additionally, it will be understood that other examples not explicitly described herein may also fall within the scope of the claims set forth below. Methods and systems for in-transit augmentation of real-time video assistance communication may provide any or all of the benefits mentioned above, as well as various additional and/or alternative benefits that will be described and/or made apparent below.

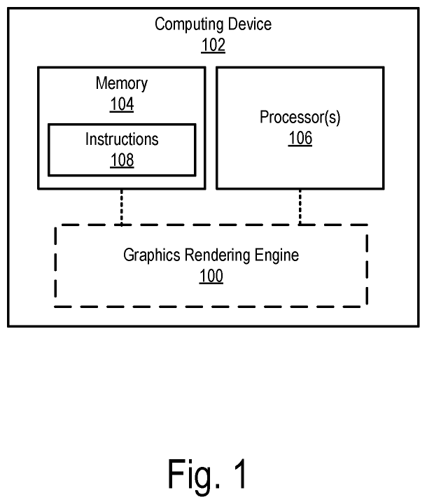

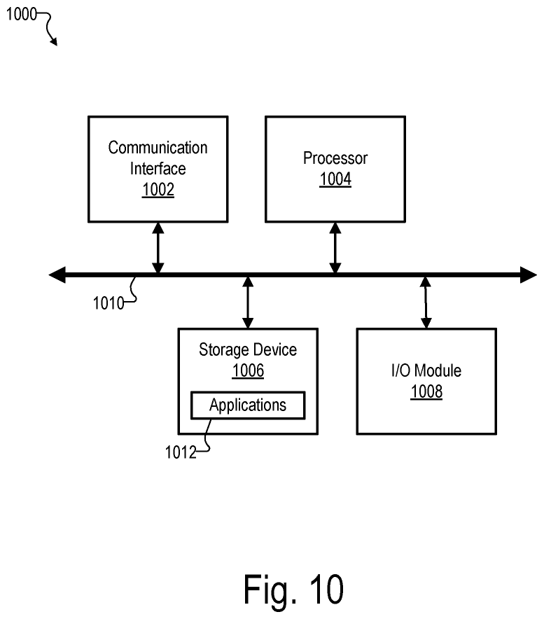

FIG. 1 shows an illustrative graphics rendering engine 100 implemented by a computing device 102 and configured to facilitate in-transit augmentation of real-time video assistance communication in accordance with principles described herein. As shown, graphics rendering engine 100 may be implemented by computer resources of computing device 102, such as processors, memory facilities, storage facilities, communication interfaces, and so forth (some of which are further described below in relation to the computing system illustrated in FIG. 10). In some examples, computing device 102 (or components thereof) may be implemented by MEC server systems operating on a provider network (e.g., a 5G cellular data network or other carrier network, etc.), cloud compute server systems running containerized applications or other distributed software, on-premise server systems, user equipment devices, or other suitable computing systems as may serve a particular implementation.

Computing device 102 may include memory resources configured to store instructions, as well as one or more processors communicatively coupled to the memory resources and configured to execute the instructions to implement graphics rendering engine 100 and perform functions described herein. For example, computing device 102 is shown in FIG. 1 to include a memory 104 and one or more processors 106 selectively and communicatively coupled to one another. Memory 104 and processors 106 may each include or be implemented by computer hardware that is configured to store and/or execute computer software such as may be implemented in instructions 108 stored in memory 104. Various other components of computer hardware and/or software not explicitly shown in FIG. 1 (e.g., networking and communication interfaces, etc.) may also be included within computing device 102 and used to implement graphics rendering engine 100. In certain embodiments, memory resources comprised in memory 104 and different processing units comprised in processors 106 may be distributed between multiple computing systems and/or multiple locations as may serve a particular implementation.

Memory 104 may store and/or otherwise maintain executable data used by processors 106 to perform any of the functionality described herein. For example, memory 104 may store instructions 108 for execution by processors 106. Memory 104 may be implemented by one or more memory or storage devices, including any memory or storage devices described herein, that are configured to store data in a transitory or non-transitory manner. Instructions 108 may be executed by processors 106 to cause graphics rendering engine 100 to perform any of the functionality described herein. Instructions 108 may be implemented by any suitable application, software, script, code, and/or other executable data instance. Additionally, memory 104 may also maintain any other data accessed, managed, used, and/or transmitted by processors 106 in a particular implementation.

Processors 106 may be implemented by one or more computer processing devices, including general-purpose processors (e.g., central processing units (CPUs), graphics processing units (GPUs), microprocessors, etc.), special-purpose processors (e.g., application-specific integrated circuits (ASICs), field-programmable gate arrays (FPGAs), etc.), or the like. Using one or more processors 106 (e.g., when the processors are directed to perform operations represented by instructions 108 stored in memory 104), graphics rendering engine 100 may be configured to perform functions associated with in-transit augmentation of real-time video assistance communication in accordance with methods and systems described herein and/or as may serve a particular implementation. While graphics rendering engine 100 will be illustrated and referred to below as a standalone system in its own right (e.g., capable of communicating with other systems, performing various operations, etc.), it will be understood that various implementations of graphics rendering engine 100 described herein may be implemented by computing devices such as computing device 102, even if such implementation details are not always explicitly mentioned or illustrated for sake of clarity.

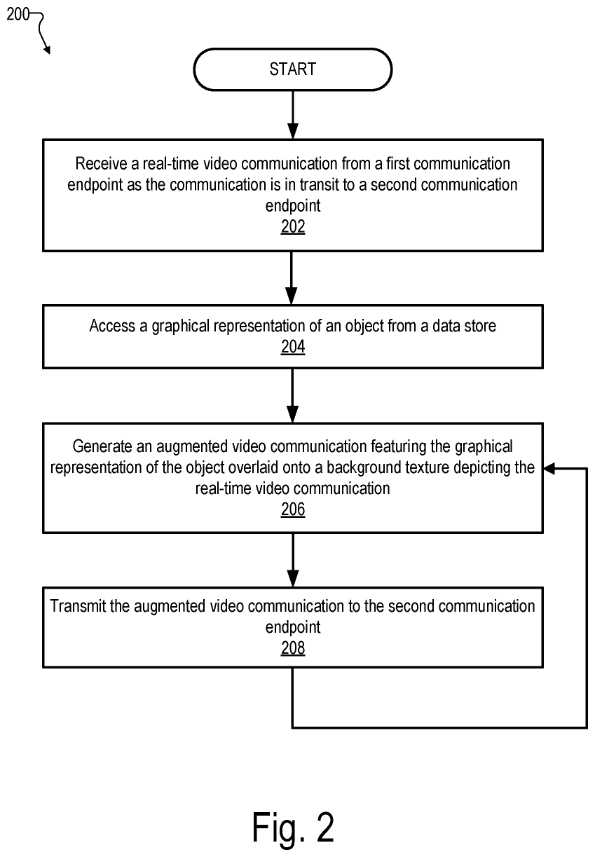

As one example of functionality that processors 106 may perform, FIG. 2 shows an illustrative method 200 for in-transit augmentation of real-time video assistance communication in accordance with principles described herein. While FIG. 2 shows illustrative operations according to one implementation, other implementations may omit, add to, reorder, and/or modify any of the operations shown in FIG. 2. In some examples, multiple operations shown in FIG. 2 or described in relation to FIG. 2 may be performed concurrently (e.g., in parallel) with one another, rather than being performed sequentially as illustrated and/or described. Additionally, as illustrated and described in more detail below, it will be understood that, during operation, graphics rendering engine 100 may perform certain operations of method 200 in a loop and/or as a continuous process (e.g., such that these operations are performed continuously in parallel) rather than performing each operation of the method merely once. One or more of the operations shown in FIG. 2 may be performed by a rendering engine such as graphics rendering engine 100 and/or any implementation thereof.

Due to the nature of the communications being enabled and facilitated by methods and systems described herein, it will be understood that operations of method 200 may be performed in real time so as to provide, receive, process, and/or use data described herein immediately as the data is generated, updated, changed, exchanged, or otherwise becomes available (e.g., receiving real-time video communications, generating real-time augmented video communications featuring graphical models or other augmented data, providing the augmented video communications to other communication endpoints, etc.). Operations described herein may therefore involve real-time data, real-time representations, real-time conditions, and/or other real-time circumstances. As used herein, “real time” will be understood to relate to data processing and/or other actions that are performed immediately, as well as conditions and/or circumstances that are accounted for as they exist in the moment when the processing or other actions are performed. For example, a real-time operation may refer to an operation that is performed immediately and without undue delay, even if it is not possible for there to be absolutely zero delay. Similarly, real-time data, real-time representations, real-time conditions, and so forth, will be understood to refer to data, representations, and conditions that relate to a present moment in time or a moment in time when decisions are being made and operations are being performed (e.g., even if after a short delay), such that the data, representations, conditions, and so forth are temporally relevant to the decisions being made and/or the operations being performed.

Each of operations 202-208 of method 200 will now be described in more detail as the operations may be performed by an implementation of graphics rendering engine 100 (e.g., by processors 106 executing instructions 108 stored in memory 104).

At operation 202, graphics rendering engine 100 may receive a real-time video communication by way of a network connection with a first communication endpoint separate from the graphics rendering engine. For example, the first communication endpoint may be associated with a business side of a transaction and the real-time video communication may be generated by a representative of that business (e.g., a human or automated sales representative or other such seller entity, a human or automated tech support representative or customer service representative or other such contact center agent, etc.). The real-time video communication may be generated at the first communication endpoint (e.g., a computing device located in a retail outlet, a call center, etc.) for communication with a second communication endpoint that is also separate from the graphics rendering engine. For example, the second communication endpoint may be associated with a client side (i.e., customer side) of the transaction and may be implemented by a computing device controlled by a customer entity who is conversing with the business representative over the video communication link.

The receiving of the real-time video communication at operation 202 may be performed as the communication is in transit or enroute from the first to the second communication endpoint. This may be performed, for example, by receiving communication data that is addressed to or otherwise intended for or sent to the second communication endpoint. To this end, the graphics rendering engine may be implemented, in some examples, within a network connecting the communication endpoints (e.g., a network such as a wireless carrier network or wide area network that provides the network connection and includes computing resources implementing the graphics rendering engine), such that the graphics rendering engine can be roughly thought of as “intercepting” and altering the communication in real time on its way to the final destination (i.e., the second communication endpoint). While the focus of the following description is on the real-time video communication transmitted from the first to the second communication endpoint (e.g., the communication from the business entity to the customer entity), it will be understood that similarly augmented or non-augmented video communications from the second to the first communication endpoints (e.g., from the customer entity to the business entity) may simultaneously be taking place.

At operation 204, the graphics rendering engine may access a graphical representation of an object. For example, the object may be a particular electronic device (e.g., a particular model of a mobile device, etc.) that the business entity desires to demonstrate or exhibit to the customer entity, and the graphical representation of that object may thus include or be implemented as a fully-manipulable 3D model of that device. The graphical representation of the object may be accessed at operation 204 from a data store that is separate from the first and second communication endpoints. In this way, neither communication endpoint (both of which may be implemented by personal computing systems having relatively modest resources compared to those available to servers in MEC or cloud data centers) may bear the burden of storing the various graphical representations of the many devices that may be available for demonstration. Rather, a cloud storage data store, a MEC storage data store, a content delivery network (CDN), or another suitable data store may be advantageously utilized to manage and maintain the potentially large amount of data representing all the different graphical representations (as well as animations and other data described herein).

At operation 206, the graphics rendering engine may generate an augmented video communication that features the graphical representation of the object overlaid onto a background texture depicting the real-time video communication. Since the receiving of the real-time video communication at operation 202 is an ongoing process (i.e., new communication data is being received and enhanced even as augmented data is being transmitted to the second communication endpoint), the generating of the augmented video communication at operation 206 may be performed as the real-time video communication is being received at operation 202. As will be described in more detail below, graphics rendering engine 100 may be configured to use incoming video from the first communication endpoint as a canvas (or “background texture”) over which the graphics rendering engine may present the graphical representation of the object accessed at operation 204. Accordingly, when presented to a viewer (e.g., the customer entity using the second communication endpoint), the augmented video communication may appear as a video showing the business representative and further showing a graphical representation of the object appearing to float in front of the representative (as will be illustrated below).

At operation 208, the graphics rendering engine transmits the augmented video communication generated at operation 206 to the second communication endpoint. As illustrated by the arrow looping back to operation 206, for example, the transmission at operation 208 may be performed in real time as the augmented video communication is being generated (and as additional communication data is being received at operation 202). As mentioned above, this allows a user at the second communication endpoint (e.g., a customer entity in various examples described herein) to view the augmented version of the video communication (with the graphical representation of the object) rather than viewing merely the original real-time video communication that was transmitted by the first communication endpoint.

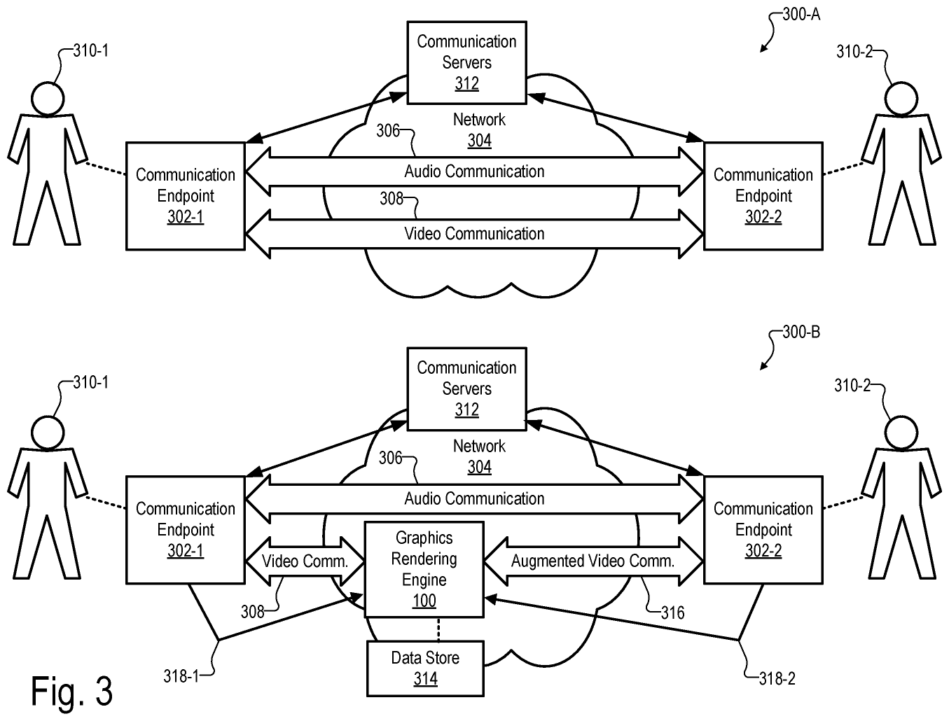

FIG. 3 shows illustrative configurations 300 (i.e., configurations 300-A and 300-B) in which video communications are conducted in accordance with principles described herein. In configuration 300-A, conventional communications are illustrated between two communication endpoints 302 (i.e., a communication endpoint 302-1 and a communication endpoint 302-2) over a network 304. Two-way audio communication 306 and video communication 308 is shown to go between communication endpoints 302 over network 304 such that respective users 310 (i.e., a user 310-1 associated with communication endpoint 302-1 and a user 310-2 associated with communication endpoint 302-2) may communicate with one another by way of their respective communication endpoints once a communicative link has been established by way of certain services performed by one or more communication servers 312.

In configuration 300-B, then, the same elements are shown together with certain modifications to illustrate how a graphics rendering engine such as graphics rendering engine 100 may be added to perform and/or facilitate in-transit augmentation of real-time video assistance communication in accordance with principles described herein. Specifically, as shown, an implementation of graphics rendering engine 100 is shown to be implemented within network 304 and to receive video communication 308 as it is in transit from communication endpoint 302-1 to communication endpoint 302-2. Graphics rendering engine 100 is shown to be communicatively coupled to a data store 314 that may store various types of data that graphics rendering engine 100 may access and overlay onto video communication 308 as graphics rendering engine 100 generates augmented video communication 316 and transmits it to communication endpoint 302-2. Additionally, configuration 300-B shows how additional data 318 (e.g., manipulation instruction data, annotation data, and/or other types of data described herein) may be provided to graphics rendering engine 100 from either or both of communication endpoints 302 (i.e., data 318-1 from communication endpoint 302-1 and data 318-2 from communication endpoint 302-2) to instruct graphics rendering engine 100 regarding certain aspects of how augmented video communication 316 is to be generated, transmitted, and/or presented.

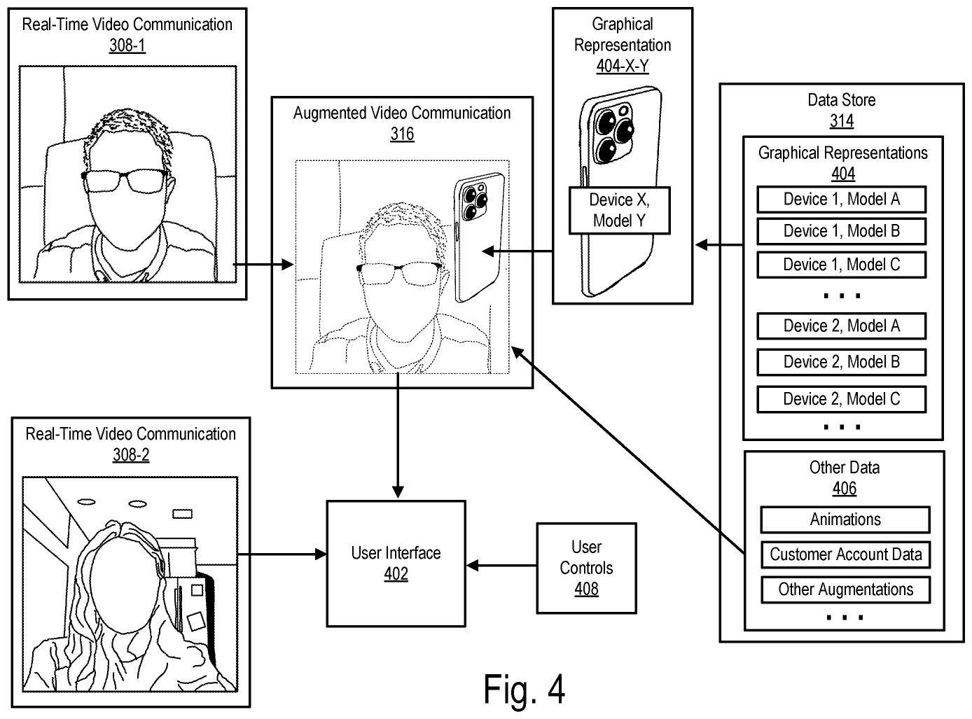

Various aspects related to how in-transit augmentation of real-time video assistance communication may be performed will now be described with reference to these various elements illustrated in FIG. 3, as well as with reference to FIG. 4.

Communication endpoints 302 represent computing devices at either end of network 304 that may be used to enable communications between users 310. For example, as described in relation to several examples mentioned above, the first communication endpoint 302-1 may be associated with a business or other such organization that may have reason to conduct transactions (e.g., sales transactions, customer support transactions, etc.) with its clientele or other stakeholders. As such, communication endpoint 302-1 may be implemented by a personal computer operated by a call center agent, seller entity, or other representative of the business (i.e., user 310-1), while the second communication endpoint 302-2 may be associated with a customer entity and may be implemented by a personal computer or mobile device operated by a customer of the business (e.g., a customer who is at home and contacting the business for support with a product, to purchase a new product, or for other similar reasons). While two separate communication endpoints 302 are shown in FIG. 3, it will be understood that certain principles described herein may also be applied to implementations in which only a single communication endpoint is employed (or where both communication endpoints 302 are implemented by a same device). For instance, a communication endpoint located in a retail store could be used by a sales or support associate and a customer standing at the same terminal to view graphical representations of objects in similar ways as described herein with regard to separate communication endpoints located at separate geographic sites.

Network 304 may represent any communicative medium or media over which data is communicated between communication endpoints 302 (e.g., whether implemented as one network or a plurality of interconnected networks). For example, network 304 may include any network or networks such as a local area network (LAN), a wide area network (WAN), the Internet, a provider network such as a cellular data network (e.g., a 5G network or data network of another suitable generation) managed by a telecommunications service provider (e.g., a cellular service provider), or the like. Network 304 may utilize any suitable protocols or technologies as may serve a particular implementation. For example, communication over network 304 may be facilitated by 5G technologies, MEC technologies, ultra-wideband technologies, and so forth.

Audio communication 306 and video communication 308 are each shown to be two-way communications between communication endpoints 302. To establish these communication channels, any suitable communication servers 312 may be used as may serve a particular implementation. As one example, communication servers 312 may include a signaling server configured to interact with communication endpoints 302 to set up communication sessions as requested by either of the communication endpoints. In such a scenario, user 310-1 may work at a retail store (or be a call center agent or other representative) for a certain company and user 310-2 may be a customer of that company. The company representative may indicate to the signaling server that he or she is ready to accept incoming calls and the customer may contact the business (e.g., through a website or app) to request a live augmented-reality video call with the representative. In some examples, the customer may indicate a specific store and requests to connect with a representative of that store, then the signaling server may forward the request to the store, where the representative may accept the request. At this point, respective communication applications executing on each side (e.g., WebRTC applications, etc.) may prompt both users for permission to use their respective devices' camera and video feeds and, when permissions are granted, a peer-to-peer communication may be established to allow for audio/video communication between the users.

Moving now to configuration 300-B more particularly, this configuration illustrates a novel system including not only the communication endpoints 302 connected by network 304, but also the data store 314 separate from the communication endpoints 302 and a computing device communicatively coupled to the communication endpoints 302 and to the data store 314 by way of network 304. As shown, this computing device may implement graphics rendering engine 100, which may be configured to perform any or all of the operations of method 200 and/or other functions described herein. As has been described, the computing device implementing graphics rendering engine 100 may be included within network 304 (e.g., as part of a MEC system, cloud system, on-premise system, etc.) such that it is in position to receive video communication 308 in transit from communication endpoint 302-1 to communication endpoint 302-2. Graphics rendering engine 100 may be implemented by any game engine or other rendering engine as may serve a particular implementation. For instance, graphics rendering engine 100 may be implemented by a web-based game engine such as Babylon.js, an Unreal Engine, or another suitable gamification engine and/or display controller that can perform functionality described herein (e.g., operations of method 200, etc.).

As directed by data 318-1 (described in more detail below), graphics rendering engine 100 may access one or more graphical representations of objects such as electronic devices, customer billing statements, etc., from data store 314, which may also be implemented by computing resources separate from communication endpoints 302 (e.g., cloud storage resources associated with network 304, etc.). Graphics rendering engine 100 may then insert this accessed graphical representation into the video communication stream in any suitable way. For instance, video communication 308 may be converted to a background texture object or canvas (e.g., using a Video as a Texture feature of the Babylon.js game engine or analogous features of other game engines, etc.) for use as a background for a video communication in which the graphical representation accessed by the game engine is presented in the foreground. In this way, graphics rendering engine 100 may mimic or imitate the client device that video communication 308 was originally intended for and that client device (i.e., communication endpoint 302-2) may receive, instead of video communication 308, the augmented video communication 316 that shows the original video communication augmented (i.e., overlaid) with the graphical object representation.

To illustrate, FIG. 4 shows various aspects relating to construction of an example user interface for real-time, augmented video communications such as illustrated in configuration 300-B. Specifically, as shown, a user interface 402 is shown to be constructed based on: 1) real-time video communication 308-2, which depicts user 310-2 (i.e., a woman with long hair in the illustrated example), and 2) augmented video communication 316, which is shown to be generated by overlaying a graphical representation 404-X-Y onto a background of real-time video communication 308-1 (which depicts user 310-1 as a man with glasses in this example). As shown, graphical representation 404-X-Y may be a graphical representation of a particular device (Device X, Model Y) that is selected from a set of graphical representations 404 stored in data store 314. Specifically, the set of graphical representations 404 may include any number of different models (e.g., including different variations, etc.) of any number of different devices (e.g., including production devices currently offered for sale, legacy devices no longer being produced, prerelease devices not yet available for purchase, etc.) of various device types as may serve a particular implementation (e.g., smartphones and other cellular phones, tablet devices, laptops and other personal computers, smart watches and other wearable devices, e-readers, and other electronic devices). For instance, as shown, certain models “Model A”, “Model B”, and “Model C” of different devices “Device 1”, “Device 2”, etc., represent potentially hundreds or thousands of different devices of every model and feature permutation that may be represented within the data store. While not shown in FIG. 4, certain data store implementations may also include graphical representations of various device accessories (e.g., cases, keyboards, batteries, charging accessories, Bluetooth headsets, etc.) that are indexed to be compatible with certain device models shown. Augmented video communication 316 is also shown to be generated based on certain other data 406 that may be stored in data store 314 or another suitable location. For example, data 406 representative of one or more animations for the graphical representation 404-X-Y of the selected device, customer account data (e.g., a representation of a billing statement, etc.), and/or other suitable augmentations may similarly be applied to augmented video communication 316 before it is presented in the user interface 402.

Another element that FIG. 4 shows to be included within user interface 402 is a set of user controls 408. These user controls may be different depending on whether user interface 402 is presented to user 310-1 at communication endpoint 302-1 (e.g., the business side of the connection where a company representative may typically have default control over certain aspects of the communication and the presentation of graphical representations 404) or is presented to user 310-2 at communication endpoint 302-2 (e.g., the client side of the connection where a customer may typically watch the presentation under control of the company representative). For instance, in examples where user interface 402 is presented at communication endpoint 302-1, user controls 408 may include a menu from which user 310-1 may select which graphical representation 404 is to be presented. This menu may allow for easy browsing of devices by brand name, by release date, or by other criteria, and may surface or recommend certain devices likely to be of interest to the customer (e.g., new or best-selling devices, updated versions of devices the customer has previously purchased, etc.). Animations, accessories, and other data that may be selected for presentation may be linked to devices in user controls 408 in ways that similarly make these things convenient for user 310-1 to find, select, and present within user interface 402.

Along with facilitating selection of which graphical representations 404 and/or other data 406 to present within the user interface 402, user controls 408 may further provide various ways of manipulating and presenting the graphical representation. For example, rotational controls (buttons with arrows pointing in each cardinal direction, etc.) may facilitate user 310-1 in rotating the graphical representation of the device or other object to exhibit its features as user 310-1 may desire, and other controls may allow user 310-1 to zoom in and out, annotate, and/or otherwise manipulate the model in any manner described herein or as may serve a particular implementation. Along with a full set of controls allowing user 310-1 to manipulate a graphical representation being presented, another user control 408 that may be available is an option to cede control of the graphical representation to user 310-2. In this way, user 310-2 (the customer in this example) may manipulate and examine a device for herself using a similar set of user controls that may be populated within the user interface presented within communication endpoint 302-2.

Returning to FIG. 3, graphics rendering engine 100 may select a particular graphical representation of a particular object (e.g., graphical representation 404-X-Y of Device X, Model Y in the example of FIG. 4) based on input from user 310-1. For example, data 318-1 may be transmitted separately from the data of video communication 308 (e.g., using an HTTPS protocol, API call, or other suitable communication), and may indicate which object or objects user 310-1 has selected for graphics rendering engine 100 to present in augmented video communication 316. Along with indicating a selection of which content is to be accessed from data store 314 (e.g., which graphical representation of which device or accessory, which customer's billing information, which animation is to be applied, etc.), data 318-1 may also indicate various aspects of how the data is to be presented and/or manipulated in the augmentation that graphics rendering engine 100 applies to video communication 308. As this data 318-1 is generated, it will also be understood that communication endpoint 302-1 may receive feedback information about augmented video communication 316 so that user 310-1 can also see (on communication endpoint 302-1) what is being provided to and presented by communication endpoint 302-2.

For example, along with transmitting augmented video communication 316 to the second communication endpoint 302-2 (as illustrated in FIG. 3), graphics rendering engine 100 may also transmit, in real time as augmented video communication 316 is being generated, augmented video communication 316 back to the first communication endpoint 302-1 (not explicitly shown in FIG. 3). This feedback to user 310-1 may be helpful to user 310-1 for various reasons, including if user 310-1 wishes to manipulate the graphical representation of the object or objects he or she is demonstrating (e.g., to rotate the model, to zoom in on a particular feature, to annotate the model to emphasize a certain characteristic, etc.). For example, graphics rendering engine 100 may receive (e.g., from communication endpoint 302-1 and as provided by user 310-1), manipulation instruction data (e.g., as part of data 318-1) that indicates a manipulation of the graphical representation of the object that is to be performed within augmented video communication 316. The graphics rendering engine may then perform (e.g., in real time as augmented video communication 316 is being generated and transmitted) the manipulation of the graphical representation of the object indicated by the manipulation instruction data. In this way, both communication endpoints will be able to see the manipulation (presented to user 310-2 and fed back for reference to user 310-1).

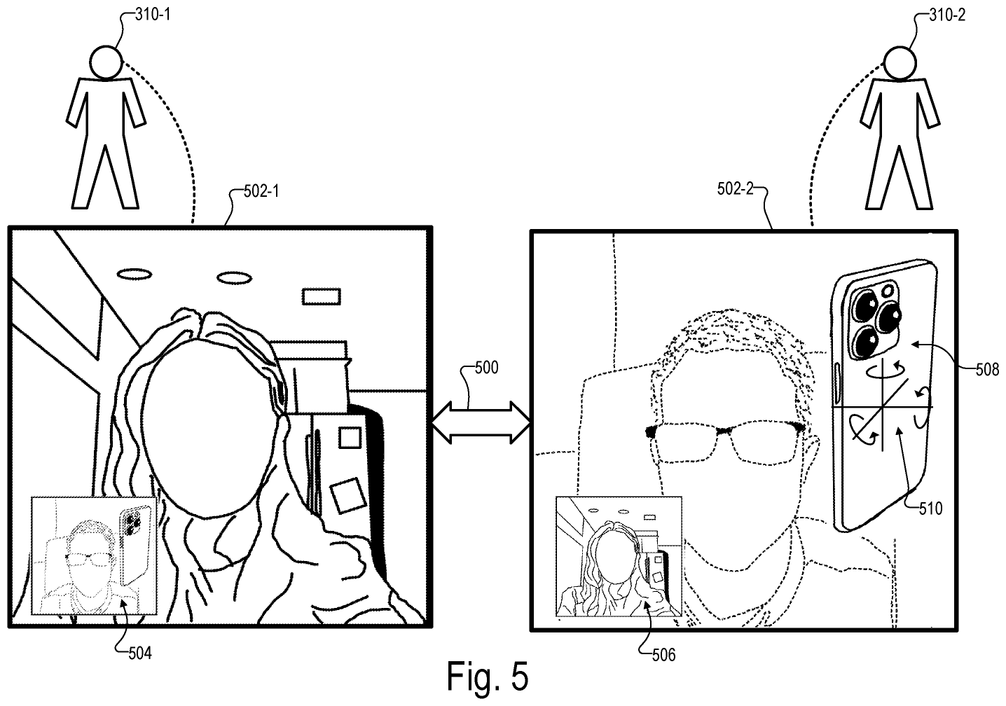

To illustrate, FIG. 5 shows illustrative snapshots of example user interfaces that may be represented on both the business and client sides of a particular transaction 500 (e.g., a sales transaction, a customer support transaction, etc.) and that may present real-time, augmented video communication as described herein. Specifically, a user interface 502-1 is shown to be presented to user 310-1 (e.g., by communication endpoint 302-1), while a user interface 502-2 is shown to be presented to user 310-2 (e.g., by communication endpoint 302-2). The content displayed in each of the user interfaces 502 may be similar or identical to any of the content described in relation to FIG. 4 to be incorporated in user interface 402. In this example, for instance, user interface 502-1 is illustrated as presenting a video communication depicting user 310-2 (the woman with long hair) provided by communication endpoint 302-2. Moreover, user interface 502-1 is also shown to be presenting feedback content 504 that displays augmented video communication 316 (including both video communication 308 depicting user 310-1 (the man with glasses) and depicting a graphical representation of a mobile device object that is being exhibited by user 310-1 to user 310-2). Along the same lines, user interface 502-2 shows the same content with different emphasis. That is, video communication 308 depicting user 310-1 is shown to be a background canvas (indicated by dotted lines instead of solid lines) onto which a graphical representation 508 of a particular object (e.g., a particular mobile device) is overlaid. In this way, user 310-2 may view user 310-1 together with the graphical representation of the object that user 310-1 is exhibiting for user 310-2. Also shown in user interface 502-2 is feedback content 506, which displays the video communication depicting user 310-2 (which communication endpoint 302-2 is capturing and transmitting to communication endpoint 302-1).

The transaction 500 that may take place between users 310-1 and 310-2 using this communication interface may be any suitable type of transaction as may serve a particular implementation. As used herein, “transactions” of various types refer to communication sessions in which at least two parties (e.g., users of communication endpoints) engage one another in conversation in pursuit of a goal such as understanding purchase options and possibly completing a sale (e.g., a sales transaction), solving a problem or having an opportunity for questions to be asked and answered (e.g., a customer support transaction), or conversing for other reasons (e.g., discussing a particular topic, getting to know one another better, etc.). Referring to transaction 500, in particular, various examples of transactions between representatives of a business or other organization (represented by user 310-1) and customers (e.g., clients, prospective clients, etc.) of that business (represented by user 310-2) are described herein.

As a first example, transaction 500 may represent a sales transaction between a seller entity (user 310-1) and a customer entity (user 310-2). In this type of example, the first communication endpoint 302-1 would be associated with the seller entity, the second communication endpoint 302-2 would be associated with the customer entity (e.g., a returning customer, a prospective customer, or anyone else interested in engaging in a sales discussion, exploring or making any type of purchase, etc.), and the augmented video communication (shown as feedback content 504 in user interface 502-1 and shown to be full-size in user interface 502-2) would be generated and transmitted in furtherance of the sales transaction. Additionally, the object represented by graphical representation 508 in this type of example would be a particular model of an electronic device being offered for sale as part of the sales transaction. Hence, in this example, user 310-1 (depicted as the man with glasses) may be understood to be in the role of a sales representative who is demonstrating certain features of the mobile phone represented by graphical representation 508 so that user 310-2 (depicted as the woman with long hair and understood to be in the role of the customer) may purchase this mobile phone if she desires.

As a second example, transaction 500 may represent a customer support transaction between a contact center agent (user 310-1) and a customer entity (user 310-2). In this type of example, the first communication endpoint 302-1 would be associated with the contact center agent (i.e., a representative of the business working in a retail store, answering calls in a call center, etc.), the second communication endpoint 302-2 would be associated with the customer entity (e.g., a customer in need of some sort of technical or account support from the business), and the augmented video communication (shown as feedback content 504 in user interface 502-1 and shown to be full-size in user interface 502-2) would be generated and transmitted in furtherance of the customer support transaction. Additionally, the object represented by graphical representation 508 in this type of example would be a particular model of an electronic device that is equivalent to a device possessed by the customer entity. Hence, in this example, user 310-1 (depicted as the man with glasses) may be understood to be in the role of a contact center agent who is offering technical or other customer support related to a mobile phone, represented by graphical representation 508, that user 310-2 (depicted as the woman with long hair and understood to be in the role of the customer) has in her possession. In this way, the call center agent may easily demonstrate to the customer what buttons she should be pressing, what the screen should look like, etc., as they work through a troubleshooting issue together or customer support is otherwise provided in any of the ways described herein.

As yet another example, transaction 500 may represent a customer support transaction between a contact center agent (user 310-1) and a customer entity (user 310-2) where the first communication endpoint 302-1 would again (as with the customer support transaction described above) be associated with the contact center agent, where the second communication endpoint 302-2 would again be associated with the customer entity, and where the augmented video communication would again be generated and transmitted in furtherance of the customer support transaction. However, in this type of example, rather than the object represented by graphical representation 508 being a 3D model of an electronic device (as explicitly shown in FIG. 5), the object represented by graphical representation 508 may be a representation of account data (e.g., billing data, personal identification information, information about a current or prospective service plan, etc.) associated with a service account of the customer entity (e.g., an account for a cellular voice/data service plan that the customer has with a mobile carrier, etc.). Hence, in this example, user 310-1 (depicted as the man with glasses) would be understood to be in the role of a contact center agent who is going over the bill (or other account details such as current or offered service plans, etc.) with user 310-2 (a customer depicted as the woman with long hair and understood to be in the role of the customer) to answer questions about the bill, make corrections, or otherwise offer billing-related customer service. In this way, the customer service representative may clearly show and review certain charges (and/or other account details) with the customer without, for example, having to engage in a conventional screen share with the customer (which may not be possible or appropriate for security/privacy reasons, given that the representative's screen could also have proprietary information or information for other customers that would not be appropriate for the customer to view).

The graphical representation 508 of the object displayed in the augmented video communication (whether that object be a mobile device such as shown in FIG. 5 or other content such as billing information described above) may be presented in two or three dimensions and in a flexible and manipulable manner aimed to make transaction 500 as efficacious and helpful to both parties as possible. For example, various manipulations 510 that may be made to graphical representation 508 are represented in FIG. 5 by a three-dimensional set of axes and arrows representing rotations about each axis. In some instances, manipulations such as rotation manipulations 510 (or other manipulations such as scaling, cropping, etc.) may be applied automatically, such as by the object being configured to automatically rotate to continuously to show the various sides of the object. In other instances, the manipulation of the object may be performed manually, such as by user 310-1 directing for a particular part of the object to be emphasized with a particular size and/or from a particular viewpoint. For example, based on manipulation instruction data provided by user 310-1 (e.g., as part of data 318, as described above), graphical representation 508 may be rotated in any suitable way and/or otherwise manipulated (e.g., scaled such as by zooming in or zooming out on a particular feature, cropped to show more emphasis on a particular portion of the device, etc.) as may be appropriate for whatever user 310-1 is attempting to demonstrate to user 310-2.

In some implementations, object manipulation control may be passed between the users 310 in a manner analogous to a representative in an in-person transaction controlling and manipulating a physical device himself (e.g., to exhibit and demonstrate certain features to a customer), then passing the physical device to the customer to control and manipulate and examine the device for herself. For example, as illustrated by data 318-2 flowing from communication endpoint 302-2 to graphics rendering engine 100 in FIG. 3, graphics rendering engine 100 may receive, from the second communication endpoint 302-2 subsequent to a transfer of object manipulation control from the first communication endpoint 302-1 to the second communication endpoint 302-2, additional manipulation instruction data (included in data 318-2) that indicates an additional manipulation of graphical representation 508 of the object that is to be performed within augmented video communication 316. As such, graphics rendering engine 100 may similarly perform this additional manipulation of graphical representation 508 of the object in real time as augmented video communication 316 continues to be generated and transmitted to both communication endpoints 302.

As described above, user controls (e.g., user controls 408) may be used by either user 310 to select objects for presentation (select which device to present as graphical representation 508), as well as to manipulate (e.g., rotate, scale, crop, zoom, push buttons, animate, etc.) the objects in any of manipulations 510 or other suitable ways. While such user controls are not explicitly shown in user interfaces 502, it will be understood that any suitable controls may be employed in the user interfaces to allow for convenient and intuitive manipulation of the object representation.

As mentioned above, one of the types of data that may be stored in data store 314 and applied to a graphical representation of an object presented within the augmented video communication is an animation associated with the particular object being exhibited. For instance, graphics rendering engine 100 may receive (e.g., from the first communication endpoint 302-1) instruction data indicating that a preproduced animation is to be applied to the graphical representation 508 of the object within the augmented video communication. For instance, the preproduced animation may be selected from a library of available preproduced animations. Depending on what type of transaction 500 is ongoing, different preproduced animations associated with different objectives may be selected and applied. For instance, in the example of a sales transaction, preproduced animations could show a close-up of certain novel features of the device being offered for sale (e.g., an updated camera with additional lenses, etc.), an exploded view of the device that illustrates new features implemented inside the device (e.g., showing a new GPU or AI chip that is being introduced, showing new sensors added since the last model, etc.), or other selling points that animations have been preproduced to draw attention to. In the example of a customer service transaction, the animation applied to the particular object may be selected to demonstrate a particular action to be performed by the customer entity with respect to the electronic device possessed by the customer entity, and the preproduced animation may be applied by the graphics rendering engine in real time as the augmented video communication is being generated and transmitted (as part of the customer support transaction). For instance, a preproduced animation showing how to switch out the SIM card of a particular device (e.g., a new phone that user 310-2 has purchased and has contacted user 310-1 to get support for) may be applied to a graphical representation of the particular device (e.g., to demonstrate how user 310-2 may perform this action with her new phone).

In some examples, the preproduced animations may show the exhibited object in different configurations (e.g., a clam-shell model that opens and closes, a SIM tray that slides out and back in) and/or may show objects other than the electronic device or other primary object that is being exhibited (e.g., showing a paper clip representation used to open a SIM tray, showing old and new SIM cards that are animated as being swapped out, etc.). Additionally, in some examples, the animations applied to graphical representation 508 may be part of a full, step-by-step tutorial video or other such presentation as may be useful in the context of a particular transaction. Such animations may be browsed and selected for application to the augmented video communication by user 310-1 in any suitable way and using any user interface controls as may serve a particular implementation.

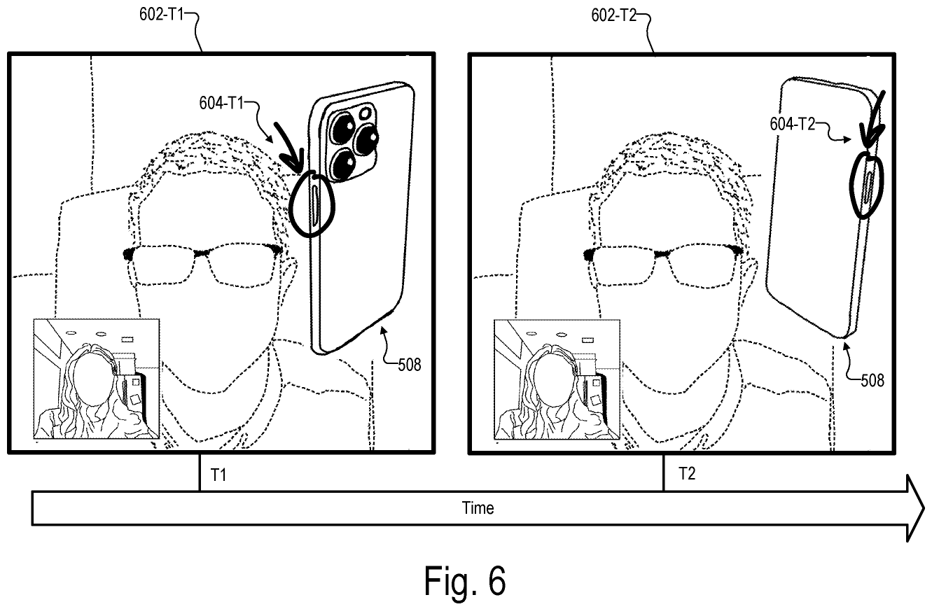

Going along with the types of manipulations (e.g., rotations, scaling, cropping, etc.) and animations that have been described in relation to FIG. 5, FIG. 6 illustrates another action that may be performed to further facilitate certain transactions such as transaction 500. Specifically, FIG. 6 shows a similar scenario to FIG. 5, where graphics rendering engine 100 similarly transmits, in real time as the augmented video communication is being generated, the augmented video communication to the first communication endpoint (providing feedback content). In this example, along with or instead of receiving object manipulation data with data 318-1, graphics rendering engine 100 may receive, from the first communication endpoint 302-1 and as part of data 318-1, annotation data indicating an annotation that is to be applied to graphical representation 508 of the object within the augmented video communication. Graphics rendering engine 100 may then apply, in real time as the augmented video communication is being generated and transmitted, the annotation indicated by the received annotation data.

To illustrate, FIG. 6 shows a user interface 602 (which is similar to user interface 502-2) at two different points in time, T1 and T2, along a timeline (an arrow labeled “Time”). More particularly, a first user interface 602-T1 shows the user interface seen by user 310-2 at communication endpoint 302-2 at time T1 after an annotation 604 has been applied to graphical representation 508 (e.g., a circle that user 310-1 drew around a particular feature of the object and an arrow pointing to that circle in this example). Annotation 604 is labeled 604-T1 at this first time T1. FIG. 6 further illustrates that, since graphical representation 508 is fully represented in 3D by the game engine, annotation 604 may be attached to the graphical representation 508 in a manner such that the annotation is manipulated together with the 3D object as the object is manipulated (e.g., rotated, scaled, etc.). To illustrate, annotation 604 is shown to be presented at a second time T2 and labeled as annotation 604-T2. Since graphical representation 508 has rotated between times T1 and T2 (rotating from showing a view of the backside of the device to showing a view of the front side of the device, where the button circled by annotation 604 is still visible), the annotation 604 is also shown to have rotated in three-dimensions together with the device, such that the arrow and circle still highlight the same feature (i.e., the particular button) at time T2 as was highlighted at time T1 (e.g., as opposed to the annotations remaining in 2D on the screen as the graphical representation rotates behind it).

Annotations such as annotation 604 may be applied by a user in any suitable way (e.g., using a touch screen user interface at communication endpoint 302-2 that supports a pen device that user 310-1 can use to draw in three dimensions on the object model). Just as manipulation control may be passed from one user to another, it may also be possible in certain implementations for user 310-1 to pass annotation control to user 310-2 in a similar way (e.g., so that the customer can make annotations as she asks questions about the device, etc.). Any suitable annotations using virtual pens or highlighters of any suitable color or type (e.g., to make different line thicknesses, line styles, etc.) may be employed as may serve a particular implementation.

In certain types of transactions, methods and systems for in-transit augmentation of real-time video assistance communication may be used for still other purposes beyond adding graphical representations of objects (e.g., electronic devices, account information statements, etc.) to video communications. As one additional example, graphics rendering engine 100 may be configured to produce a machine-readable code that indicates information related to the transaction that is being carried out. For instance, in the example of a sales transaction in which the object represented by the graphical representation overlaid onto the augmented video communication is the particular model of the electronic device being offered for sale, the machine-readable code may indicate the particular model of the electronic device (e.g., the details of the device that the user has converged upon and decided to purchase after conversing with the sales representative and potentially learning about several different models). Additionally, the machine-readable code may indicate information such as the identity of the sales representative that has been helping the customer (e.g., in case a commission is to be attributed to the representative for the customer's purchase), and/or other information as may serve a particular implementation. The augmented video communication generated by the graphics rendering engine may feature the machine-readable code overlaid onto the background texture (e.g., either alongside graphical representation 508 of the object or as a replacement for graphical representation 508 of the object), so that the machine-readable code can facilitate the customer entity in completing the sales transaction subsequent to a presentation of the augmented video communication at the second communication endpoint 302-2.

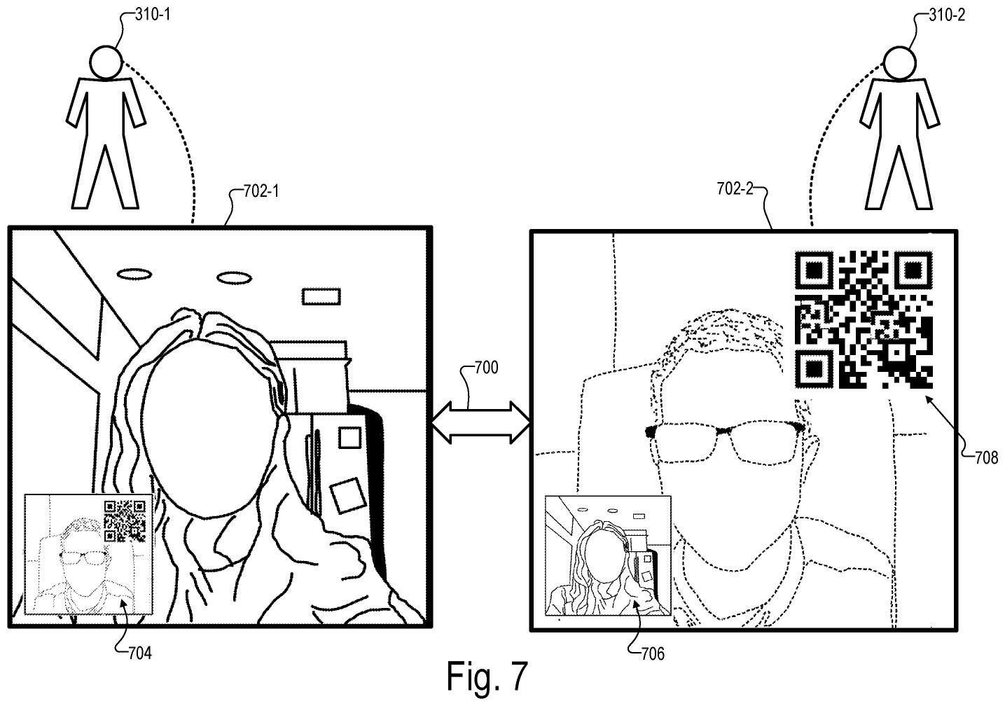

To illustrate, FIG. 7 shows a sales transaction 700 similar to sales-related examples of transaction 500 illustrated and described above. As with the examples illustrated by FIG. 5, FIG. 7 shows that a first user interface 702-1 may include a video communication depicting user 310-2 (i.e., the woman with long hair, again in the role of the customer entity in this example) and, in some examples, feedback content 704 depicting the augmented video communication generated by the graphics rendering engine. FIG. 7 further shows that a second user interface 702-2 may include the augmented video communication that depicts user 310-1 (the man with glasses, again in the role of the seller entity in this example) and optional feedback content 706 depicting user 310-2.

Whereas FIG. 5 showed example of an electronic device that was either being offered for sale (in the sales transaction example) or being referred to in the context of customer service for a device that the customer already possessed (in the customer support example), FIG. 7 shows a machine-readable code 708 that may be encoded with information that indicates a precise object that user 310-2 has selected for purchase (e.g., a particular make and model of an electronic device, including an indication of certain variations or optional features that have been added on or selected to the selected device), the identity of the seller entity (i.e., user 310-1) who has helped the customer come to that purchase decision, and/or any other information as may serve a particular implementation. While a QR code is shown in FIG. 7, it will be understood that other types of machine-readable codes (e.g., bar codes, NFC or RFID codes, etc.) may similarly be employed to facilitate user 310-2 in completing her purchase at the end of a sales transaction with user 310-1. In this way, once the customer entity represented by user 310-2 has decided which device she would like to purchase (with the help of the seller entity represented by user 310-1), she may use her current phone or another device to scan machine-readable code 708 presented on the screen to conveniently and confidently ensure that she orders the correct device. For example, machine-readable code 708 may be encoded with a URL that takes her to a landing page where she inputs payment and shipping information to complete the sale and where the particular sales associate (user 310-1 in this example) can be automatically credited with facilitating the sale (e.g., so that user 310-1 may receive a commission, have his sales statistics updated, etc.).

Specific examples described and illustrated up to this point have generally involved augmented video communications that are overlaid with an individual graphical representation of a single object (e.g., a 3D model of a particular device being offered for sale, a 3D model of a device possessed by the customer entity and that is the subject of a customer support transaction, etc.). In certain examples, it may also be beneficial to overlay a video communication with a plurality of graphical representations of multiple objects.

A first example of where multiple graphical representations may be advantageous is in the context of a sales transaction. In such a scenario, for instance, graphics rendering engine 100 may access (from data store 314) a graphical representation of an additional object and augmented video communication 316 (generated by graphics rendering engine 100 as described above) may further feature the graphical representation of the additional object overlaid onto the background texture alongside the graphical representation of the object. For example, if the object represented by the first graphical representation is one particular model of an electronic device being offered for sale, the additional object may be a different model of the electronic device that is also being offered for sale as an alternative to the particular model in the sales transaction (e.g., a similar but competing model associated with a different brand, a similar model that is a different color or has different variations, etc.). As another example, the object represented by the first graphical representation could be the particular model of the electronic device being offered for sale, while the additional object could be a different model of the electronic device that is familiar to the customer entity and presented to facilitate a comparison with the particular model. For instance, the additional object could be a legacy electronic device model that the customer entity currently owns (or has owned in the past) and is considering upgrading to a new or different model. In this example, the additional object may not be offered for sale as part of the sales transaction (e.g., since the additional object may be an older model that the customer has owned for several years and is no longer being produced), but is presented to facilitate a side-by-side comparison between the familiar old model and what the customer is considering upgrading to.

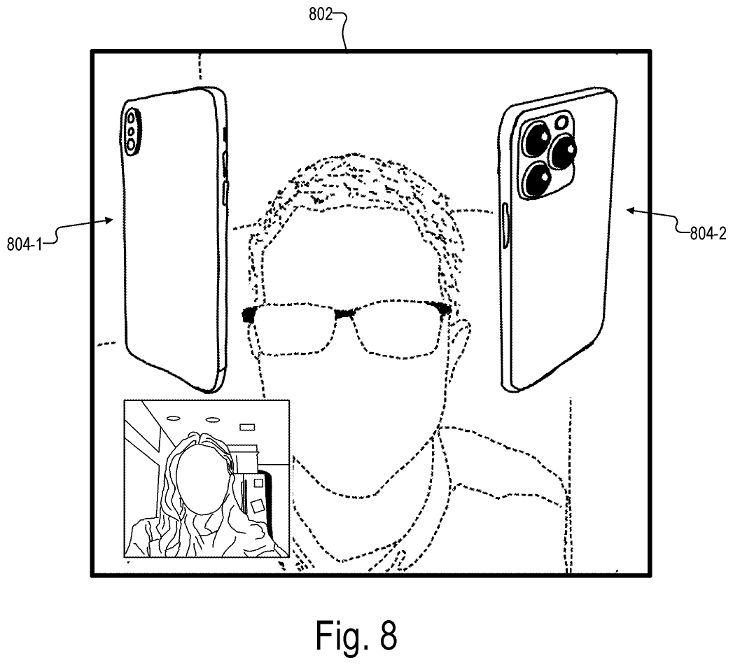

To illustrate, FIG. 8 shows a user interface 802 that includes the same elements already described in relation to other client-side user interfaces such as user interfaces 502-2, 602-T1, 602-T2, and 702-2. However, whereas these other user interfaces show only a single device object being overlaid onto the augmented video communication, user interface 802 illustrates that both a first graphical representation 804-1 of a first object and a second graphical representation 804-2 of a second object may be overlaid onto the augmented video communication. For example, graphical representation 804-1 may represent a first model of a mobile device being offered for sale, graphical representation 804-2 may represent a similar, competing model of mobile device also being offered for sale, and user interface 802 may be presented to allow user 310-1 to demonstrate similarities and differences between the two models to help user 310-2 make a decision about which device to purchase. As another example, graphical representation 804-1 may represent the model of the mobile device that the customer entity already has and is familiar with, graphical representation 804-2 may represent a new model of mobile device being offered for sale (e.g., a model that the customer is considering upgrading to), and user interface 802 may be presented to allow user 310-1 to demonstrate similarities and differences between the two models to help user 310-2 determine if she wishes to upgrade to the new model.

Another example of where multiple graphical representations may be advantageous is in the context of a customer support transaction. In such a scenario, for instance, graphics rendering engine 100 may again access (from data store 314) a graphical representation of an additional object, while augmented video communication 316 (generated by graphics rendering engine 100 as described above) may again feature the graphical representation of the additional object overlaid onto the background texture alongside the graphical representation of the object. In this customer support transaction, however, the first object may be a particular model of electronic device equivalent to a device already possessed by the customer entity, while the additional object may be a different particular model of the electronic device that is equivalent to an additional electronic device possessed by the customer entity. For instance, the first object may be a phone that the customer has been using for several years (and that she recently upgraded) and the additional object may be the customer's new phone (that she upgraded to and that she is requesting help in getting set up). In this scenario, the two different objects may be presented to demonstrate a particular action that is to be performed by the customer entity with respect to both the electronic device and the additional electronic device as part of the customer support transaction. For instance, if the customer has requested help transferring contacts and/or other information from her old phone to her newly-purchased phone, the objective of the customer support transaction may be to assist the user in performing the action of transferring that content and the graphical representations of both her old and new phones may be useful to demonstrate exactly what steps she is to perform to effect that action.

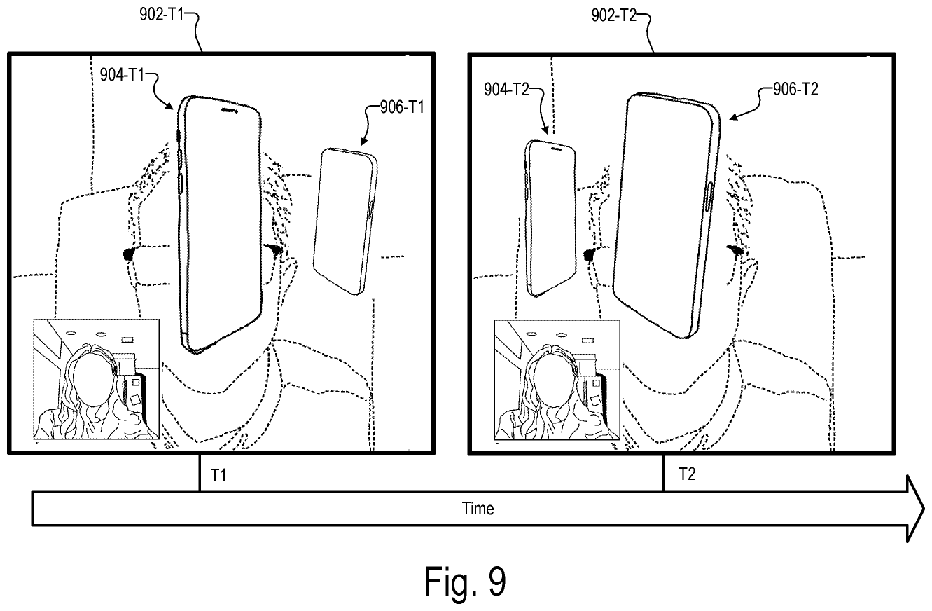

To illustrate, FIG. 9 shows the same timeline described above in relation to FIG. 6 and illustrates a user interface 902 (analogous to other client-side user interfaces described above) at times T1 (i.e., user interface 902-T1) and T2 (i.e., user interface 902-T2). In the example of FIG. 9, both user interfaces 902-T1 and 902-T2 are shown to present augmented video communications that illustrate the video communication depicting user 310-1 (i.e., the seller entity) overlaid with two graphical representations 904 and 906 of two different objects (e.g., different mobile devices in this example). More specifically, at time T1 user interface 902-T1 shows that a graphical representation 904-T1 of the first mobile device may be emphasized by being presented front and center and at a larger scale than a graphical representation 906-T1 of the second mobile device. At time T1, certain steps of a procedure configured to transfer data from the first device to the second device may be performed on the first device and so these steps may be illustrated with the first device highlighted. Conversely, by time T2, later steps in the procedure may be performed on the second device. As such, at time T2, user interface 902-T2 shows that a graphical representation 904-T2 of the first mobile device may be deemphasized (shown to be smaller and off to the side) while a larger, centered graphical representation 906-T2 of the second mobile device is highlighted instead. By switching back and forth between which device is highlighted, the customer service or technical support agent (i.e., user 310-1 in this example) may clearly and conveniently demonstrate which steps are to be performed on each of the two devices, what each device should look like as each step is performed, and so forth.

As described above, user controls (e.g., user controls 408) may be used to select objects for presentation (select which devices to present as graphical representation 904 and 906), as well as to manipulate and switch between these objects (i.e., switch which device is emphasized, as is shown to change between time T1 and time T2). In some examples, a predefined animation that embodies the procedure may automatically switch between the objects as appropriate (highlighting whichever device is the subject of a present step of the procedure being demonstrated). User controls may also allow for a manual override so that user 310-1 may choose to emphasize either device at any time or switch between them in a way that was not predefined (e.g., to back up and help the customer complete a step that was missed, etc.). While such user controls are not explicitly shown in user interfaces 902, it will be understood that any suitable controls may be employed in the user interfaces to allow for convenient and intuitive manipulation of the object representations by either user 310.

In certain embodiments, one or more of the processes described herein may be implemented at least in part as instructions embodied in a non-transitory computer-readable medium and executable by one or more computing devices. In general, a processor (e.g., a microprocessor) receives instructions, from a non-transitory computer-readable medium (e.g., a memory, etc.), and executes those instructions, thereby performing one or more operations such as the operations described herein. Such instructions may be stored and/or transmitted using any of a variety of known computer-readable media.

A computer-readable medium (also referred to as a processor-readable medium) includes any non-transitory medium that participates in providing data (e.g., instructions) that may be read by a computer (e.g., by a processor of a computer). Such a medium may take many forms, including, but not limited to, non-volatile media, and/or volatile media. Non-volatile media may include, for example, optical or magnetic disks and other persistent memory. Volatile media may include, for example, dynamic random-access memory (DRAM), which typically constitutes a main memory. Common forms of computer-readable media include, for example, a disk, hard disk, magnetic tape, any other magnetic medium, a compact disc read-only memory (CD-ROM), a digital video disc (DVD), any other optical medium, random access memory (RAM), programmable read-only memory (PROM), electrically erasable programmable read-only memory (EPROM), FLASH-EEPROM, any other memory chip or cartridge, or any other tangible medium from which a computer can read.

FIG. 10 shows an illustrative computing system 1000 that may implement graphics rendering engines for in-transit augmentation of real-time video assistance communication and/or other computing systems described herein. For example, computing system 1000 may include or implement (or partially implement) a computing device (e.g., computing device 102) that implements any of various rendering engine embodiments that have been described herein (e.g., including various implementations of graphics rendering engine 100). Additionally or alternatively, computing system 1000 may implement any of the elements illustrated in FIG. 3 or other examples herein, including communication endpoints 302, communication servers 312, elements of network 304, systems implementing data store 314, and/or any other computing devices or systems described herein (or any elements or subsystems thereof).

As shown in FIG. 10, computing system 1000 may include a communication interface 1002, a processor 1004, a storage device 1006, and an input/output (I/O) module 1008 communicatively connected via a communication infrastructure 1010. While an illustrative computing system 1000 is shown in FIG. 10, the components illustrated in FIG. 10 are not intended to be limiting. Additional or alternative components may be used in other embodiments. Components of computing system 1000 shown in FIG. 10 will now be described in additional detail.

Communication interface 1002 may be configured to communicate with one or more computing devices. Examples of communication interface 1002 include, without limitation, a wired network interface (such as a network interface card), a wireless network interface (such as a wireless network interface card), a modem, an audio/video connection, and any other suitable interface.

Processor 1004 generally represents any type or form of processing unit capable of processing data or interpreting, executing, and/or directing execution of one or more of the instructions, processes, and/or operations described herein. Processor 1004 may direct execution of operations in accordance with one or more applications 1012 or other computer-executable instructions such as may be stored in storage device 1006 or another computer-readable medium.

Storage device 1006 may include one or more data storage media, devices, or configurations and may employ any type, form, and combination of data storage media and/or device. For example, storage device 1006 may include, but is not limited to, a hard drive, network drive, flash drive, magnetic disc, optical disc, RAM, dynamic RAM, other non-volatile and/or volatile data storage units, or a combination or sub-combination thereof. Electronic data, including data described herein, may be temporarily and/or permanently stored in storage device 1006. For example, data representative of one or more executable applications 1012 configured to direct processor 1004 to perform any of the operations described herein may be stored within storage device 1006. In some examples, data may be arranged in one or more databases residing within storage device 1006.

I/O module 1008 may include one or more I/O modules configured to receive user input and provide user output. One or more I/O modules may be used to receive input for a single virtual experience. I/O module 1008 may include any hardware, firmware, software, or combination thereof supportive of input and output capabilities. For example, I/O module 1008 may include hardware and/or software for capturing user input, including, but not limited to, a keyboard or keypad, a touchscreen component (e.g., touchscreen display), a receiver (e.g., an RF or infrared receiver), motion sensors, and/or one or more input buttons.

I/O module 1008 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O module 1008 is configured to provide graphical data to a display for presentation to a user. The graphical data may be representative of one or more graphical user interfaces and/or any other graphical content as may serve a particular implementation.

In some examples, any of the facilities described herein may be implemented by or within one or more components of computing system 1000. For example, one or more applications 1012 residing within storage device 1006 may be configured to direct processor 1004 to perform one or more processes or functions associated with any of processors 106 of computing device 102. Likewise, memory 104 of computing device 102 may be implemented by or within storage device 1006.

To the extent the aforementioned implementations collect, store, or employ personal information of individuals, groups or other entities, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various access control, encryption and anonymization techniques for particularly sensitive information.

In the preceding description, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method comprising:
receiving, by a graphics rendering engine and by way of a network connection with a first communication endpoint separate from the graphics rendering engine, a real-time video communication generated at the first communication endpoint for communication with a second communication endpoint separate from the graphics rendering engine;
accessing, by the graphics rendering engine from a data store separate from the first and second communication endpoints, a graphical representation of an object;
generating, by the graphics rendering engine as the real-time video communication is being received, an augmented video communication featuring the graphical representation of the object overlaid onto a background texture depicting the real-time video communication; and
transmitting, by the graphics rendering engine in real time as the augmented video communication is being generated, the augmented video communication to the second communication endpoint.

2. The method of claim 1, further comprising:
transmitting, by the graphics rendering engine in real time as the augmented video communication is being generated, the augmented video communication to the first communication endpoint;
receiving, by the graphics rendering engine from the first communication endpoint, manipulation instruction data indicating a manipulation of the graphical representation of the object that is to be performed within the augmented video communication; and
performing, by the graphics rendering engine in real time as the augmented video communication is being generated and transmitted, the manipulation of the graphical representation of the object indicated by the manipulation instruction data.

3. The method of claim 2, further comprising:
receiving, by the graphics rendering engine from the second communication endpoint subsequent to a transfer of object manipulation control from the first communication endpoint to the second communication endpoint, additional manipulation instruction data indicating an additional manipulation of the graphical representation of the object that is to be performed within the augmented video communication; and
performing, by the graphics rendering engine in real time as the augmented video communication is being generated and transmitted, the additional manipulation of the graphical representation of the object indicated by the additional manipulation instruction data.

4. The method of claim 1, further comprising:
transmitting, by the graphics rendering engine in real time as the augmented video communication is being generated, the augmented video communication to the first communication endpoint;
receiving, by the graphics rendering engine from the first communication endpoint, annotation data indicating an annotation that is to be applied to the graphical representation of the object within the augmented video communication; and
applying, by the graphics rendering engine in real time as the augmented video communication is being generated and transmitted, the annotation indicated by the annotation data.

5. The method of claim 1, wherein:
the first communication endpoint is associated with a seller entity, the second communication endpoint is associated with a customer entity, and the augmented video communication is generated and transmitted in furtherance of a sales transaction between the seller entity and the customer entity; and
the object is a particular model of an electronic device being offered for sale as part of the sales transaction.

6. The method of claim 5, further comprising accessing, by the graphics rendering engine from the data store, a graphical representation of an additional object;
wherein:
the augmented video communication generated by the graphics rendering engine further features the graphical representation of the additional object overlaid onto the background texture alongside the graphical representation of the object; and
the additional object is a different model of the electronic device and is offered for sale as an alternative to the particular model in the sales transaction.

7. The method of claim 5, further comprising accessing, by the graphics rendering engine from the data store, a graphical representation of an additional object;
wherein:
the augmented video communication generated by the graphics rendering engine further features the graphical representation of the additional object overlaid onto the background texture alongside the graphical representation of the object; and
the additional object is a different model of the electronic device that is familiar to the customer entity and is presented to facilitate a comparison with the particular model while not being offered for sale as part of the sales transaction.

8. The method of claim 5, further comprising producing, by the graphics rendering engine, a machine-readable code that indicates the particular model of the electronic device;
wherein:
the augmented video communication generated by the graphics rendering engine further features the machine-readable code overlaid onto the background texture alongside the graphical representation of the object or as a replacement for the graphical representation of the object; and
the machine-readable code is configured to facilitate the customer entity in completing the sales transaction subsequent to a presentation of the augmented video communication at the second communication endpoint.

9. The method of claim 1, wherein:
the first communication endpoint is associated with a contact center agent, the second communication endpoint is associated with a customer entity, and the augmented video communication is generated and transmitted in furtherance of a customer support transaction between the contact center agent and the customer entity; and
the object is a particular model of an electronic device that is equivalent to a device possessed by the customer entity.

10. The method of claim 9, further comprising:
receiving, by the graphics rendering engine from the first communication endpoint, instruction data indicating that a preproduced animation is to be applied to the graphical representation of the object within the augmented video communication to demonstrate a particular action to be performed by the customer entity with respect to the electronic device possessed by the customer entity; and
applying, by the graphics rendering engine in real time as the augmented video communication is being generated and transmitted, the preproduced animation to the graphical representation of the object as part of the customer support transaction.

11. The method of claim 9, further comprising accessing, by the graphics rendering engine from the data store, a graphical representation of an additional object;
wherein:
the augmented video communication generated by the graphics rendering engine further features the graphical representation of the additional object overlaid onto the background texture alongside the graphical representation of the object; and
the additional object is a different particular model of the electronic device that is equivalent to an additional electronic device possessed by the customer entity and that is presented to demonstrate a particular action to be performed by the customer entity with respect to both the electronic device and the additional electronic device as part of the customer support transaction.

12. The method of claim 1, wherein:
the first communication endpoint is associated with a contact center agent, the second communication endpoint is associated with a customer entity, and the augmented video communication is generated and transmitted in furtherance of a customer support transaction between the contact center agent and the customer entity; and
the object is a representation of account data associated with a service account of the customer entity.

13. A system comprising:
a first communication endpoint;
a data store separate from the first communication endpoint; and
a computing device communicatively coupled to the first communication endpoint and to the data store by way of a network, the computing device implementing a graphics rendering engine configured to:
receive a real-time video communication generated at the first communication endpoint as the real-time video communication is in transit to a second communication endpoint by way of the network;
access, from the data store, a graphical representation of an object;
generate, as the real-time video communication is being received, an augmented video communication featuring the graphical representation of the object overlaid onto a background texture depicting the real-time video communication; and
transmit, in real time as the augmented video communication is being generated, the augmented video communication to the second communication endpoint.

14. The system of claim 13, wherein the graphics rendering engine is further configured to:
transmit, in real time as the augmented video communication is being generated, the augmented video communication to the first communication endpoint;
receive, from the first communication endpoint, manipulation instruction data indicating a manipulation of the graphical representation of the object that is to be performed within the augmented video communication; and
perform, in real time as the augmented video communication is being generated and transmitted, the manipulation of the graphical representation of the object indicated by the manipulation instruction data.

15. A system comprising:
a memory storing instructions; and
one or more processors communicatively coupled to the memory and configured to execute the instructions to perform a process comprising:
receiving, by way of a network connection with a first communication endpoint separate from the system, a real-time video communication generated at the first communication endpoint for communication with a second communication endpoint separate from the system;
accessing, from a data store separate from the first and second communication endpoints, a graphical representation of an object;
generating, as the real-time video communication is being received, an augmented video communication featuring the graphical representation of the object overlaid onto a background texture depicting the real-time video communication; and
transmitting, in real time as the augmented video communication is being generated, the augmented video communication to the second communication endpoint.

16. The system of claim 15, wherein the process further comprises:
transmitting, in real time as the augmented video communication is being generated, the augmented video communication to the first communication endpoint;
receiving, from the first communication endpoint, manipulation instruction data indicating a manipulation of the graphical representation of the object that is to be performed within the augmented video communication; and
performing, in real time as the augmented video communication is being generated and transmitted, the manipulation of the graphical representation of the object indicated by the manipulation instruction data.

17. The system of claim 15, wherein the process further comprises:
transmitting, in real time as the augmented video communication is being generated, the augmented video communication to the first communication endpoint;
receiving, from the first communication endpoint, annotation data indicating an annotation that is to be applied to the graphical representation of the object within the augmented video communication; and
applying, in real time as the augmented video communication is being generated and transmitted, the annotation indicated by the annotation data.

18. The system of claim 15, wherein:
the first communication endpoint is associated with a seller entity, the second communication endpoint is associated with a customer entity, and the augmented video communication is generated and transmitted in furtherance of a sales transaction between the seller entity and the customer entity; and
the object is a particular model of an electronic device being offered for sale as part of the sales transaction.

19. The system of claim 15, wherein:
the first communication endpoint is associated with a contact center agent, the second communication endpoint is associated with a customer entity, and the augmented video communication is generated and transmitted in furtherance of a customer support transaction between the contact center agent and the customer entity; and
the object is a particular model of an electronic device that is equivalent to a device possessed by the customer entity.

20. The system of claim 15, wherein:
the first communication endpoint is associated with a contact center agent, the second communication endpoint is associated with a customer entity, and the augmented video communication is generated and transmitted in furtherance of a customer support transaction between the contact center agent and the customer entity; and
the object is a representation of account data associated with a service account of the customer entity.
